(19) United States
(12) Patent Application Publication
(10) Pub. No.: US 2003/0142141 A1
(43) Pub. Date: Jul. 31, 2003

(54) Displaying specified resource usage

(75) Inventors: Michael Wayne Brown, Georgetown, TX (US); Andrew Douglas Hately, Austin, TX (US); Kelvin Roderick Lawrence, Round Rock, TX (US); Michael A. Paolini, Austin, TX (US)

Correspondence Address: Marilyn Smith Dawkins, International Business Machines Corporation, Intellectual Property Law Dept. Internal Zip 4054, 11400 Burnet Road, Austin, TX, 78758, US

(73) Assignee: International Business Machines Corporation, Armonk, NY

(21) Appl. No.: 10/059,093

(22) Filed: Jan. 28, 2002

(51) Int. Cl. G09G 5/00

(52) U.S. Cl. 345/805

(57) ABSTRACT

A method, system and program for displaying specified resource usage are provided. A usage status is determined for resources utilized by a computer system. Responsive to detecting a window displayed within a user interface in association with a particular system element (e.g. software, hardware, network) from among multiple system elements, adjusting a shading of a preexisting window element within the window to indicate the usage status of at least one of the resources as utilized by the particular system element, such that a display area for specifying the usage of at least one of the resources avoids consuming additional screen real estate for a status indicator.

### CROSS-REFERENCE TO RELATED APPLICATIONS

The present application is related to the following co-pending applications, which are filed on even date herewith and incorporated herein by reference:

(1) U.S. patent application Ser. No. ______ (Attorney Docket No. AUS920010514US1); and

(2) U.S. patent application Ser. No. ______ (Attorney Docket No. AUS920010515US1);

(3) U.S. patent application Ser. No. ______ (Attorney Docket No. AUS920010516US1);

(4) U.S. patent application Ser. No. ______ (Attorney Docket No. AUS920010517US1);

(5) U.S. patent application Ser. No. ______ (Attorney Docket No. AUS920010518US1);

(6) U.S. patent application Ser. No. ______ (Attorney Docket No. AUS920010519US1);

(7) U.S. patent application Ser. No. ______ (Attorney Docket No. AUS920010520US1);

(8) U.S. patent application Ser. No. ______ (Attorney Docket No. AUS920010521US1);

(9) U.S. patent application Ser. No. ______ (Attorney Docket No. AUS920010522US1);

(10) U.S. patent application Ser. No. ______ (Attorney Docket No. AUS920010524US1); and

(11) U.S. patent application Ser. No. ______ (Attorney Docket No. AUS920010525US1).

### BACKGROUND OF THE INVENTION

1. Technical Field

The present invention relates in general to computer systems and, in particular, to graphical user interfaces. Still more particularly, the present invention relates to measuring and indicating system element specified resource usage with minimized screen real estate usage within a graphical user interface.

2. Description of the Related Art

Most computer systems include multiple types of software for controlling the functions of the computer system. A first type of software is system software (operating systems), which controls the workings of the computer. A second main type of software is applications, such as word processing programs, spreadsheets, databases, and browsers, which perform the tasks for which people use computers. In addition, a computer system may include network software, which enables groups of computers to communicate, and language software, which provides programmers with the tools they need to write programs.

Software contains many instructions typically executed by a processor and other hardware within a computer system. As instructions are executed, the status or progress of multiple parts of the computer system is often monitored. In particular, the status is the condition, at a particular time, of any of numerous elements of computing including, but not limited to, a device, a communications channel, a network station, a software program, a bit, or another element. A status may be utilized to report on or to control computer operations.

Most system software provides a graphical user interface (GUI) for controlling a visual computer environment. The GUI represents programs, files, and options with graphical images, such as icons, menus, and dialog boxes on the screen. Graphical items defined within the GUI work the same way for the user in most software because the GUI provides standard software routines to handle these elements and report the user's actions.

A typical graphical element defined by a GUI is a window or other defined area of a display containing distinguishable text, graphics, video, audio and other information for output. A display area may contain multiple windows associated with a single software program or multiple software programs executing concurrently.

A GUI typically provides multiple window elements displayed with each window. For example, typical window elements include a title bar containing the name of the window, selectable icons for adjusting the size of the window, and scroll bars for adjusting the displayable portion of information within a window.

Some software applications add a status bar or indicator as another independent window element for indicating status within a software application. In particular, such status information may include the location of a cursor, whether the application is ready or waiting, and an estimated time until the application will be ready.

As an example, a status bar associated with a browser may include a graphical bar incorporated within the window that adjusts in color depending on the amount of information received for a web page. A status bar associated with a word processing program at the bottom edge of the word processing program window may indicate the page number, line number, and other pertinent information about where a cursor is currently placed in a text document. A status bar associated with language software may indicate in an independent pop-up window the time left for code to compile.

A user may open multiple windows within a display area where an active window is displayed in front of all other open windows. However, a user may also select for the active window and other open windows to be transparent. For example, in U.S. Pat. No. 5,892,511 where multiple windows are open, the top-level windows are displayed as translucent such that the user may view windows positioned below. Displaying windows as transparent allows a user to view window elements such as title bars for windows that would otherwise be covered.

Alternatively, a feature of most system software allows a user to minimize an open window or windows into an icon, text or other graphical representation displayed such that when selected, the window reopens. In particular, by minimizing windows, the screen space utilized for the window is reduced to allow the user to maximize use of the area available for display.

While the translucency of entire windows and the ability to minimize windows aid the user in adding as much information as possible to a screen area, such GUI features are limited where a user also needs to view the status of different elements represented within multiple windows. In particular, when a window has been minimized into an icon or other graphical element, the status depicted in the window is no longer visible.

As a further limitation of GUI features, each window has multiple elements such that the space utilized for those features is not minimized. For example, a title bar, a status bar, and a scroll bar each require display space for each window. Where multiple windows are open, the screen space utilized for redundant window elements increases.

Moreover, a limitation of most operating systems is that resource utilization specified according to application is not provided except by a user opening a new window that utilizes additional screen space and lists resource utilization for all applications.

In view of the foregoing, it would be advantageous to provide a method, system, and program for utilizing the title bar or other preexisting window element to also indicate usage of at least one resource corresponding to a system element such that the space necessary for each window is minimized. Moreover, it would be advantageous to provide a method, system, and program for indicating usage status of a system element in association with a window whether that window is minimized or maximized.

### SUMMARY OF THE INVENTION

In view of the foregoing, it is therefore an object of the present invention to provide an improved computer system.

It is another object of the present invention to provide an improved graphical user interface.

It is yet another object of the present invention to provide a method, system and program for measuring and indicating system element specified resource usage with minimal screen space usage within a graphical user interface.

According to one aspect of the present invention, a usage status is determined for resources utilized by a computer system. Responsive to detecting a window displayed within a user interface in association with a particular system element from among multiple system elements, adjusting a shading of a preexisting window element within the window to indicate the usage status of at least one of the resources as utilized by the particular system element, such that a display area for specifying the usage of at least one of the resources avoids consuming additional screen real estate for a status indicator. Examples of preexisting window elements include, but are not limited to, title bars, scroll bars, frame handles, and minimized window icons.

According to another aspect of the present invention, adjustment of the shading of a preexisting window element may include adjusting a transparent image overlay within the preexisting window element. The adjustment of the transparent image overlay may be in the form of a gradient increasing in a particular direction to indicate usage status.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a graphical representation of a window in which usage of multiple resources is illustrated in accordance with the method, system, and program of the present invention;

FIG. 3 depicts a graphical representation a window in which usage of a single resource is illustrated with a transparent gradient shading in accordance with the method, system, and program of the present invention;

FIG. 4 illustrates a graphical representation of a window in which resource usage images are depicted within scroll bars in accordance with the method, system, and program of the present invention;

FIG. 5 depicts a graphical representation of a browser window in which resource usage is imaged for each frame in accordance with the method, system, and program of the present invention;

FIG. 6 illustrates a graphical representation of a user interface in which minimized windows illustrate resource usage in accordance with the method, system, and program of the present invention;

FIG. 7 depicts a high level logic flowchart of a process and program for controlling resource usage images in accordance with the method, system, and program of the present invention.

### DETAILED DESCRIPTION OF THE PREFERRED EMBODIMENT

A method, system, and program for displaying resource usage specified according to system element is provided. Further, the screen space utilized for displaying resource usage specified according to system element is minimized, wherein additional screen real estate is not consumed for a status indicator. In the present invention, a system element may include, but is not limited to, a software element, a hardware element, or a network element associated with a computer system. The present invention is particularly useful for software applications utilizing large amounts of resources and network software.

Software elements include, but are not limited to, software applications, operating systems, language programs and other code based documents executing within a computer system, accessible to a computer system, or accessed by a computer system. Hardware elements include, but are not limited to, hardware functioning within a computer system and peripherals accessible to a computer system. Network elements include, but are not limited to, network software, network hardware and network interfacing.

In addition, in the present invention, “resource usage” may include, but is not limited to, usage of software elements, hardware elements, and network elements. In particular, displaying resource usage is advantageous where specified for usage of memory, graphics cards, sound cards, printers, operating systems, buses, input devices, output devices, number of CPUs, number of threads, direct access storage devices (DASDs), and net bandwidth and other software, hardware, and network resources. As will be understood by one skilled in the art, the actual monitoring of the usage of a resource may be performed by hardware or software within a computer system or received as input to a computer system. In addition, as will be understood by one skilled in the art, the conversion of the usage of a resource to a graphical representation of status may be performed by hardware or software within a computer system or received as input to a computer system.

Further, for the purposes of this invention, a “window” may be a traditional rectangular region on a display in which data is displayed, as well as smaller sub-regions, such as pop-up, pull-down, or other menus, icons, symbols, or other display elements, and objects, generally. A window may distribute across the entirety of a display area and may be incorporated into the background of a display area. In addition, a window may utilize definable borders or may utilize a logical representation area without definable borders. In addition, a minimized “window” may be represented by a selectable icon within a user interface.

While the present invention is described with emphasis upon windows and selectable icons, the invention may be applied to any graphical object. Graphical objects may include, but are not limited to, text, icons, video, graphics, windows, or other graphical representations displayable within a display area.

Accordingly, it will be appreciated that the apparatus and method of the present invention has application to any object displayed, regardless of the shape, size or function of the object in any particular computer display system. In addition, it will be appreciated that when a window is referenced, the software controlling the information within the window is also referenced and that while the present invention refers to minimization of windows, that multiple windows may be minimized into a single icon and that a software application may be minimized into a single icon.

Further, it will be appreciated that multiple windows may be opened within a display area, where the multiple windows are displayed in association with multiple independent software applications. The graphical elements associated with the software application may be hidden, while the windows opened in association with the software application remain open, such that windows from multiple hidden software applications may overlap one another.

A “window element” is preferably a distinguishable element a GUI provides for each window. For example, window elements may include, but are not limited to, title bars, scroll bars, and menu bars. In addition, a window element may include the icon or graphical element representing a minimized window. Furthermore, a window element may include all the additional bars and graphics specified within a window according to each individual software application. A preexisting window element is any window element other than those uniquely specified for a window to illustrate status.

Advantageously, resource usage is depicted within a window element already defined by the GUI or an application, such that additional screen space is not allocated solely for depicting resource usage. In particular, different types of shading are preferable for depicting resource usage. Shading may include, but is not limited to, hues, colors, gradients, transparency, three-dimensional effects, and other graphical features supported by a system.

Transparency is a graphical shading feature that is particularly advantageous to the present invention when incorporating a resource usage image within already defined window elements. By making a resource usage image appear transparent on a computer screen, other elements below the resource usage element are visible through the resource usage element. Further, the transparency of a resource usage image may be adjusted from opaque to totally transparent.

Typically, the transparency attribute is stored with color values in an alpha channel. Then, when calculating the appearance of a given pixel, the graphic processor uses the alpha channel values to determine the pixel's color through a process termed alpha blending. Through alpha blending, the process adds a fraction of the color of the transparent object set by the alpha channel value to the color of the window element. Mixing the colors together gives the appearance that the window element is seen through a layer of the transparent resource usage image. In addition to alpha blending, additional shading may be added to create shadows and other graphical images to cue the viewer to the position of the transparent resource usage image.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

### Hardware Overview

The present invention may be executed in a variety of systems, including a variety of computing systems and electronic devices under a number of different operating systems. In one embodiment of the present invention, the computing system is a portable computing system such as a notebook computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

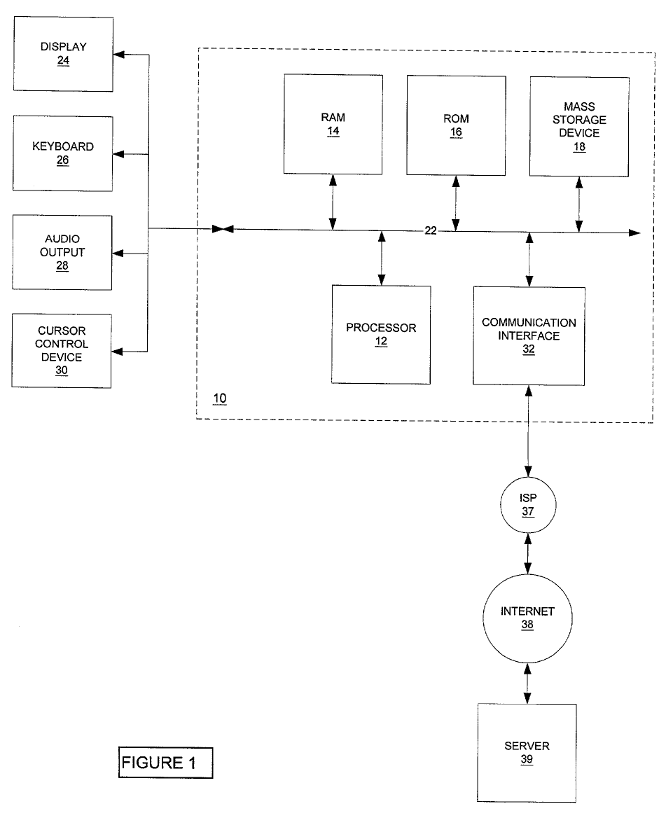

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

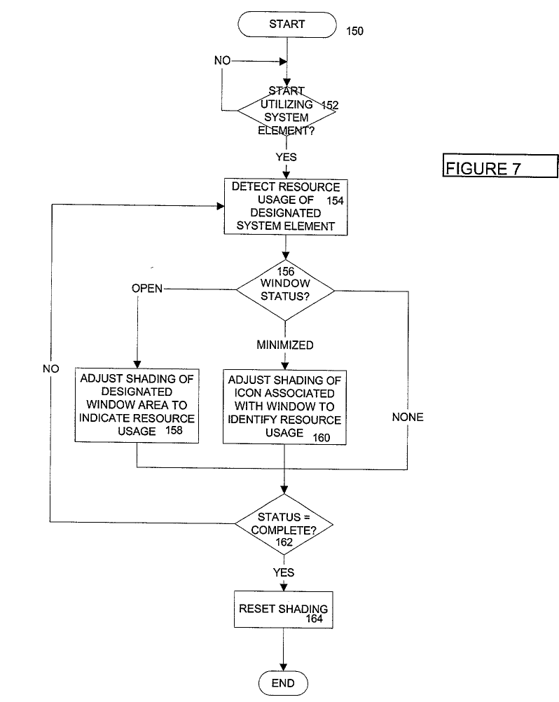

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIG. 7 and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communication interface 32, which carry the digital or analog data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. Display 24 may include both non-transparent surfaces, such as monitors, and transparent surfaces, such as headset sunglasses or vehicle windshield displays.

A keyboard 26 and cursor control device 30, such as a mouse, trackball, or cursor direction keys, are coupled to bus 22 as interfaces for user inputs to computer system 10. It should be understood that keyboard 26 and cursor control device 30 are examples of multiple types of input devices that may be utilized in the present invention. In alternate embodiments of the present invention, additional input and output peripheral components may be added.

### Resource Usage Specified According to System Element

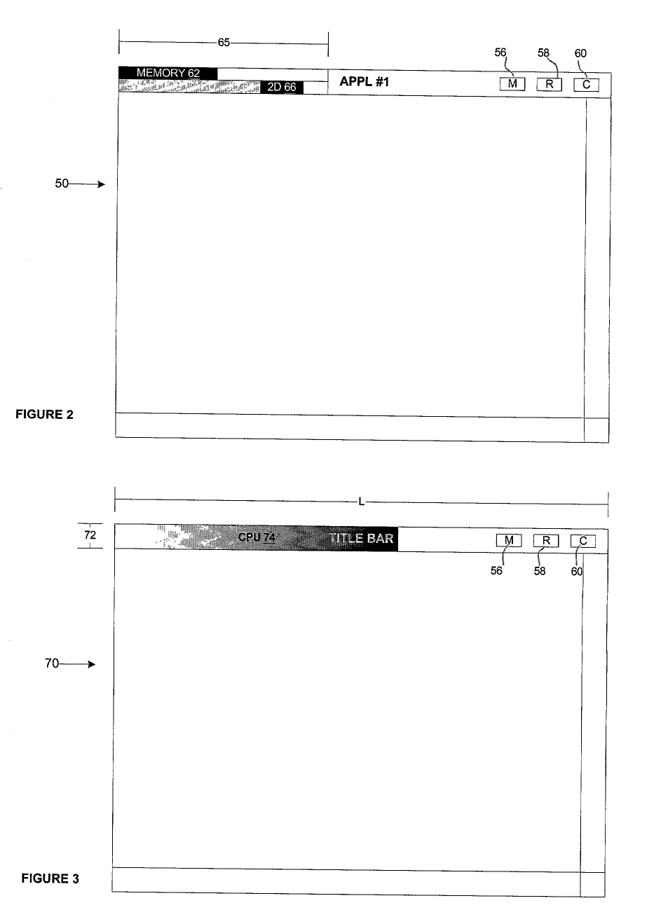

With reference now to FIG. 2, there is depicted a graphical representation of a window in which usage of multiple resources is illustrated in accordance with the method, system, and program of the present invention. As illustrated, a window 50 incorporates preexisting window elements, including a title bar 60. Title bar 60 is a standard, preexisting graphical element utilized within a window by many operating systems. Typically, the title within a title bar does not utilize all the space within a title bar.

In addition, included within the space utilized by title bar 60, are typically selectable icons, such as selectable icons 56, 58, and 59, which when selected adjust a characteristics of window 50. In the present example, selection of selectable icon 56 will initiate minimization of window 50 into a selectable icon within the display area. Selection of selectable icon 58 will restore the window to a previous size. In addition, selection of selectable icon 59 will close window 50.

As an advantage of the present invention, the space utilized by title bar 60 also includes resource usage indicators 62, 64, and 66. In the present example, resource usage indicator 62 indicates a percentage of memory utilized by “APPL #1”, which is advantageously an application executing on the computer system. In addition, in the present example, resource usage indicator 64 indicates a percentage of a graphics card utilized for generating three-dimensional (3D) graphics while resource usage indicator 66 indicates a percentage of a graphics card utilized for generating two-dimensional (2D) graphics. The combination of resource usage indicators 64 and 66 indicate the total percentage of resources utilized from the graphics card.

In particular, in the present example, resource usage indicators 62, 64 and 66 utilize shaded bars increasing from left to right within the length of title bar 60 indicated by reference numeral 65 to indicate increases in usage of a resource. However, in alternate embodiments, alternate types of graphical tools may be utilized within title bar 60 to indicate resource usage by the application associated with window 50.

Referring now to FIG. 3, there is depicted a graphical representation a window in which usage of a single resource is illustrated with a transparent gradient shading in accordance with the method, system, and program of the present invention. As illustrated, a window 70 incorporates preexisting window elements, including title bar 72. Within title bar 72 is transparent gradient shaded bar 74. In the present example, use of the length (L) of title bar 72 indicates 100% usage of a CPU. Transparent gradient shaded bar 74 increases from left to right along title bar 72 to indicate increases in usage by the system element associated with window 70.

Advantageously, a gradient shading within transparent gradient shaded bar 74 indicates the direction of increase from left to right. Additionally, the translucency of gradient shaded bar 74 allows the title and selectable icons 56, 58, and 59 to be depicted through transparent gradient shaded bar 74 as the bar increases to the right. The translucency of transparent gradient shaded bar 74 may be designated as a preference by a user or determined by the operating system according to factors such as the screen color, other transparent graphical objects, and the shading of other elements within the title bar.

With reference now to FIG. 4, there is illustrated a graphical representation of a window in which resource usage images are depicted within scroll bars in accordance with the method, system, and program of the present invention. As depicted, a window 80 incorporates preexisting window elements, including horizontal scroll bar 82 and a vertical scroll bar 84. Scroll bars are typical GUI window elements utilized within windows to allow a user to adjust the viewable portion of a document within window 80.

Position bars 83 and 85 are associated with each of scroll bars 82 and 84. Position bar 83 indicates a position of the document currently in view along the horizontal axis and position bar 85 indicates a position of the document currently in view along the vertical axis.

According to one advantage of the present invention, the screen space utilized by scroll bars 82 and 84 is also utilized to depict resource usage images 86 and 88 where the length of each of scroll bars 82 and 84 is utilized to indicate full usage of a monitored resource. In the present example, resource usage image 86 is an adjustable transparent gradient bar for indicating the usage of “CPU1”. In addition, in the present example, resource usage image 88 is a transparent bar that oscillates in transparency and/or hue to represent the frequency spectrum of audio received by an audio card.

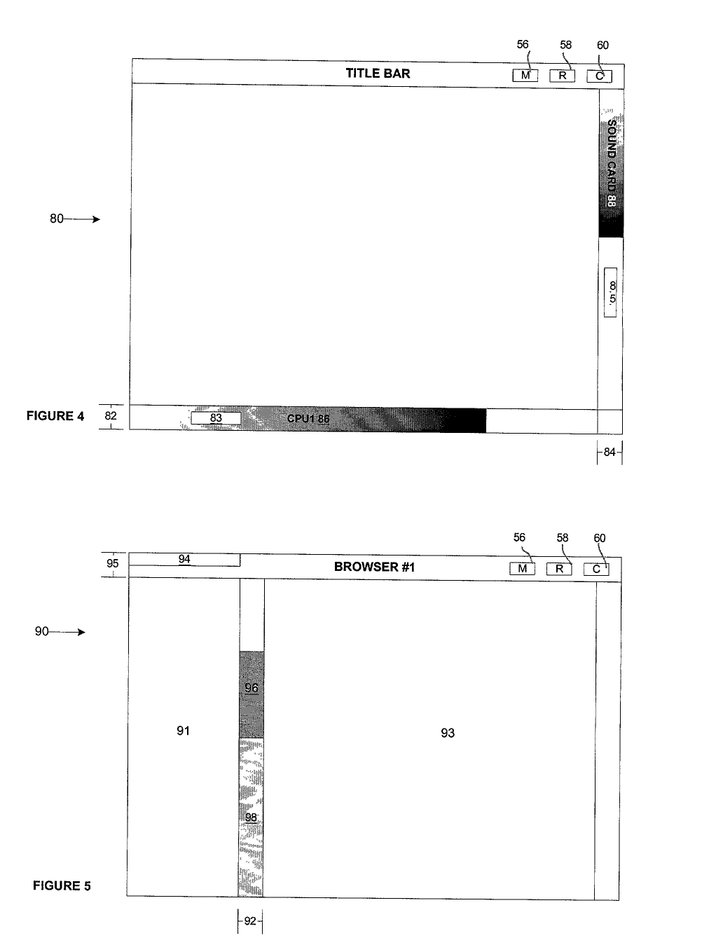

Referring now to FIG. 5, there is depicted a graphical representation of a browser window in which resource usage is imaged for each frame in accordance with the method, system, and program of the present invention. As illustrated, a browser window 90 for displaying web pages includes frames 91 and 93. Frames 91 and 93 are separated by frame divider 92.

Advantageously, frame divider 92 includes a resource usage image 96. In the present example, resource usage image 96 is a bar that increases in size from bottom to top to indicate increases in information received for frame 91. When the bar reaches the top of frame divider 92, the bar indicates that the frame has finished loading. Resource usage image 96 may include alternate types of shading, including a gradient to indicate a direction of increase and transparency. In addition, in alternate embodiments, resource usage image 96 may include graphical images other than a bar, such as an icon that multiplies within frame divider 92 to indicate increases in information.

A second resource usage image 98 is transparently overlaid across resource usage image 96 within frame divider 92. Advantageously resource usage image 98 is also a bar that increases from top to bottom, but indicates memory utilization by frame 91. As illustrated, resource usage image 98 is transparent, such that resource usage image 96 is rendered visible through resource usage image 98.

According to one advantage of the present invention, resource usage may be depicted for frames within a web page, as well as for the web page as a whole. In the present example, a title bar 95 within window 90 includes a resource usage image 94 that increases from left to right to indicate an increase in overall information received for the web page.

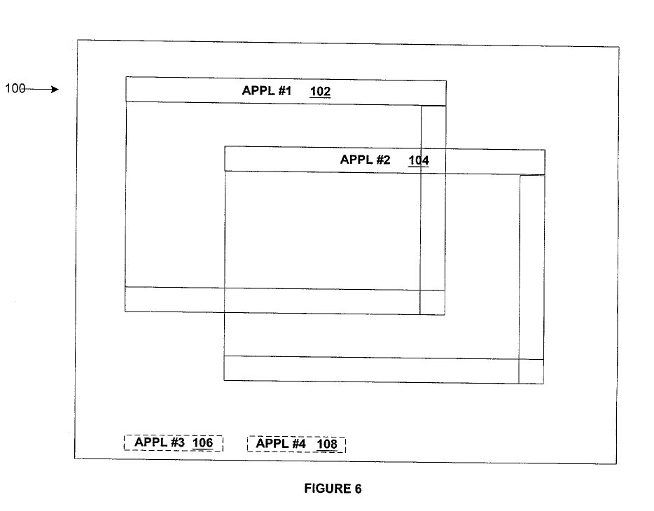

With reference now to FIG. 6, there is depicted a graphical representation of a user interface in which minimized windows illustrate resource usage in accordance with the method, system, and program of the present invention. As illustrated, a user interface 100 includes open windows 102 and 104. In addition, user interface 100 includes minimized windows 106 and 108, where a selectable icon represents each minimized window.

According to one advantage of the present invention, resource usage by a system element associated with a minimized window continues to be depicted within the screen area utilized by the icon representing the minimized window. In the present example, a transparent area represented by dotted lines overlaps each of minimized windows 106 and 108. The transparent area represents a resource usage image for depicting resource usage by the applications associated with minimized windows 106 and 108. In the example, as resource usage for of at least one resource adjusts, the transparent area adjusts in transparency and may adjust in hue or other characteristic, such that if CPU usage reaches a max, the transparent area becomes completely opaque to hide the minimized window icons from view. While in the present example, usage for a single resource is described, in alternate embodiments, multiple transparent and other shaded graphical features may be added to a minimized window screen space to depict multiple resources being utilized.

Referring now to FIG. 7, there is illustrated a high level logic flowchart of a process and program for controlling resource usage images in accordance with the method, system, and program of the present invention. As depicted, the process starts at block 150 and thereafter proceeds to block 152. Block 152 depicts a determination as to whether a new system element has started to be utilized. Utilization of a new system element may be initiated by opening an application, starting a computer or other piece of hardware, or initiating a network connection. In addition, where the window or other screen representation is initiated for a system element, then the system element may start to be utilized. If a system element has not started to be utilized, then the process iterates at block 152. If a system element has started to be utilized, then the process passes to block 154.

Block 154 depicts detecting the resource usage of multiple resources by the designated system element. Next, block 156 illustrates a determination as to the window status associated with the system element. If the window status is an open window, then the process passes to block 158. If a window status is a minimized window, then the process passes to block 160. If the window status is none, then the process passes to block 162.

Block 158 depicts adjusting the shading of a selected window element within the open window to indicate resource usage of at least one resource; and the process passes to block 162. Block 160 illustrates adjusting the shading of a graphical element incorporated with the screen space for a minimized window icon according to resource usage of at least one resource; and the process passes to block 162.

Block 162 illustrates a determination as to whether the system element has stopped being utilized. The system element may stop being utilized, for example, by closing an application or stopping utilization of a particular piece of hardware. If the system element has not stopped being utilized, then the process passes to block 154. If the system element has stopped being utilized, then the process ends.

While the invention has been particularly shown and described with reference to a preferred embodiment, it will be understood by those skilled in the art that various changes in form and detail may be made therein without departing from the spirit and scope of the invention.

What is claimed is:

1. A method for displaying specified resource usage according to a system element, said method comprising the steps of:
determining a usage status for at least one resource utilized by a computer system; and
responsive to detecting a window displayed within a user interface in association with a particular system element from among a plurality of system elements, adjusting a shading of a preexisting window element within said window to indicate said usage status of said at least one resource as utilized by said particular system element, such that a display area for specifying said usage of said at least one resource avoids utilizing additional screen real estate for creating a status indicator.

2. The method for displaying specified resource usage according to claim 1, said step of determining a usage status, further comprising the step of:
determining said usage status for said at least one resource comprising at least one from among a software element, a hardware element, and a network element.

3. The method for displaying specified resource usage according to claim 1, said method further comprising the step of:
detecting said window displayed within said user interface in association with a particular system element from among a plurality of system elements, wherein said plurality of system elements comprise at least one from among a software element, a hardware element, and a network element.

4. The method for displaying specified resource usage according to claim 1, said method further comprising the step of:
detecting said window displayed within said user interface in association with a particular system element from among a plurality of system elements, wherein said window is open within said user interface.

5. The method for displaying specified resource usage according to claim 1, said method further comprising the step of:
detecting said window displayed within said user interface in association with a particular system element from among a plurality of system elements, wherein said window is minimized within said user interface.

6. The method for displaying specified resource usage according to claim 1, said step of adjusting a shading further comprising the step of:
adjusting a transparent image overlay within said window element to indicate usage status.

7. The method for displaying specified resource usage according to claim 1, said step of adjusting a shading further comprising the step of:
adjusting a transparent image overlay in a gradient increasing in a particular direction to indicate usage status.

8. The method for displaying specified resource usage according to claim 1, said step of adjusting a shading further comprising the step of:
adjusting a shading of a preexisting window element, wherein said preexisting window element comprises at least one from among a title bar, a scroll bar, a frame handle, and a minimized window icon.

9. A system for displaying specified resource usage comprising:
a graphical user interface;
means for determining a usage status for at least one resource utilized by a computer system; and
means responsive to detecting a window displayed within a said graphical user interface in association with a particular system element from among a plurality of system elements, adjusting a shading of a preexisting window element within said window to indicate said usage status of said at least one resource as utilized by said particular system element.

10. The system for displaying specified resource usage according to claim 9, said means for determining a usage status further comprising:
means for determining said usage status for said at least one resource comprising at least one from among a software element, a hardware element, and a network element.

11. The system for displaying specified resource usage according to claim 9, said system further comprising:
means for detecting said window displayed within said graphical user interface in association with a particular system element from among a plurality of system elements, wherein said plurality of system elements comprise at least one from among a software element, a hardware element, and a network element.

12. The system for displaying specified resource usage according to claim 9, said system further comprising:
means for detecting said window displayed within said graphical user interface in association with a particular system element from among a plurality of system elements, wherein said window is open within said user interface.

13. The system for displaying specified resource usage according to claim 9, said system further comprising:
means for detecting said window displayed within said graphical user interface in association with a particular system element from among a plurality of system elements, wherein said window is minimized within said user interface.

14. The system for displaying specified resource usage according to claim 9, said means for adjusting a shading further comprising:
means for adjusting a transparent image overlay within said window element to indicate usage status.

15. The system for displaying specified resource usage according to claim 9, said means for adjusting a shading further comprising:
means for adjusting a transparent image overlay in a gradient increasing in a particular direction to indicate usage status.

16. The system for displaying specified resource usage according to claim 9, said means for adjusting a shading further comprising:
means for adjusting a shading of a preexisting window element, wherein said preexisting window element comprises at least one from among a title bar, a scroll bar, a frame handle, and a minimized window icon.

17. A program for displaying specified resource usage, residing on a computer usable medium having computer readable program code means, said program comprising:
means for determining a usage status for at least one resource utilized by a computer system; and
means for controlling adjustment of a shading of a preexisting window element within a window within a graphical user interface to indicate said usage status of said at least one resource as utilized by a particular system element associated with said window from among a plurality of system elements.

18. The program for displaying specified resource usage according to claim 17, said program further comprising:
means for determining said usage status for said at least one resource comprising at least one from among a software element, a hardware element, and a network element.

19. The program for displaying specified resource usage according to claim 17, said program further comprising:
means for detecting said window displayed within said graphical user interface in association with a particular system element from among a plurality of system elements, wherein said plurality of system elements comprise at least one from among a software element, a hardware element, and a network element.

20. The program for displaying specified resource usage according to claim 17, said program further comprising:
means for detecting said window displayed within said graphical user interface in association with a particular system element from among a plurality of system elements, wherein said window is open within said user interface.

21. The program for displaying specified resource usage according to claim 17, said program further comprising:
means for detecting said window displayed within said graphical user interface in association with a particular system element from among a plurality of system elements, wherein said window is minimized within said user interface.

22. The program for displaying specified resource usage according to claim 17, said program further comprising:
means for controlling adjustment of a transparent image overlay within said window element to indicate usage status.

23. The program for displaying specified resource usage according to claim 17, said program further comprising:
means for controlling adjustment of a transparent image overlay in a gradient increasing in a particular direction to indicate usage status.

24. The program for displaying specified resource usage according to claim 17, said program further comprising:
means for controlling adjustment of a shading of a preexisting window element, wherein said preexisting window element comprises at least one from among a title bar, a scroll bar, a frame handle, and a minimized window icon.
